(19) United States
(12) Patent Application Publication
(10) Pub. No.: US 2026/0359689 A1
(43) Pub. Date: Nov. 12, 2026

(54) Method and Apparatus for Processing Data Processing Task, Storage Medium, and Electronic Device

(71) Applicant: Origin Quantum Computing Technology (Hefei) Co., Ltd, Hefei (CN)

(72) Inventors: Panpan LU, Hefei (CN); Ye LI, Hefei (CN); Menghan DOU, Hefei (CN)

(73) Assignee: Origin Quantum Computing Technology (Hefei) Co., Ltd, Hefei (CN)

(21) Appl. No.: 18/587,354

(22) Filed: Feb. 26, 2024

Related U.S. Application Data
(63) Continuation of application No. PCT/CN2023/078928, filed on Mar. 1, 2023.

(30) Foreign Application Priority Data
Mar. 4, 2022 (CN) 202210214645.X
Mar. 4, 2022 (CN) 202210214966.X
Mar. 4, 2022 (CN) 202210214967.4
Mar. 4, 2022 (CN) 202210214969.3

(51) Int. Cl. G06N 10/20; G06F 17/13

(52) U.S. Cl. CPC G06N 10/20; G06F 17/13

(57) ABSTRACT

Disclosed are a method and an apparatus for processing a data processing task, a non-transitory computer-readable storage medium, and an electronic device. The method includes: acquiring data of a data processing task, where the data processing task is a task to solve a differential equation, and the data of the data processing task includes the differential equation; constructing a differentiable quantum circuit based on the data of the data processing task; and predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result.

### CROSS-REFERENCE TO RELATED APPLICATIONS

This application is a continuation of International Application No. PCT/CN2023/078928, filed on Mar. 1, 2023, which claims priority to Chinese Patent Application No. 202210214967.4, filed on Mar. 4, 2022, Chinese Patent Application No. 202210214969.3 filed on Mar. 4, 2022, Chinese Patent Application No. 202210214966.X, filed on Mar. 4, 2022, and Chinese Patent Application No. 202210214645.X, filed on Mar. 4, 2022. The disclosures of the aforementioned applications are hereby incorporated by reference in their entireties.

### TECHNICAL FIELD

Implementations of this application relate to the field of data processing, and in particular, to a method and an apparatus for processing a data processing task, a storage medium, and an electronic device.

### BACKGROUND

In the field of computers, a hardware or software function is mainly implemented in a form of processing a data processing task. In a processing process of executing a data processing task according to input data, an output processing result of the data processing task is used as a direct output of a designated function or an instruction for implementing the designated function.

In many scientific technical fields (such as fluid mechanics, finance, biology, and chemistry), a large amount of data processing tasks relate to solving a differential equation, and how to precisely and quickly process the data processing tasks for solving the differential equation shows a very important application value.

In an existing method for solving a differential equation, since a solution of the differential equation in an entire computational domain is directly solved, there is a problem of relatively high resource consumption for performing grid division in the computational domain.

Quantum computing is a new computing mode, and the principle is to build a computing framework by using quantum mechanical theory. Quantum computing has an exponential acceleration effect over an optimal classical algorithm in solving a particular problem.

### SUMMARY

Implementations of this application provide a method and an apparatus for processing a data processing task, a storage medium, and an electronic device, to reduce resource consumption caused by grid division.

An implementation of this application provides a method for processing a data processing task, and the method includes: acquiring data of a data processing task, where the data processing task is a task to solve a differential equation, and the data of the data processing task includes the differential equation; constructing a differentiable quantum circuit based on the data of the data processing task; and predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result.

In another implementation of this application, the predicting a target processing result of the data processing task based on the differentiable quantum circuit includes: predicting a target solution of the differential equation based on a variational parameter in the differentiable quantum circuit.

In another implementation of this application, the data of the data processing task further includes an initial condition and a boundary condition satisfied by a solution of the differential equation. The step of constructing a differentiable quantum circuit based on the data of the data processing task includes: constructing the differentiable quantum circuit based on the differential equation as well as the initial condition and boundary condition that are satisfied by the solution of the differential equation, and determining a variational parameter in the differentiable quantum circuit.

In another implementation of this application, the constructing the differentiable quantum circuit based on the differential equation and the initial condition and boundary condition satisfied by the solution of the differential equation includes: acquiring a set of qubits and setting an initial state of the qubits to |0 [symbol] constructing, by using a first type of quantum logic gates, a first quantum sub-circuit module for generating a function space basis set; constructing, by using a second type of quantum logic gates, a second quantum sub-circuit module for combining the function space basis set into a predicted solution of the differential equation; constructing a measurement operation module for obtaining the predicted solution of the differential equation; and sequentially combining the first quantum sub-circuit module, the second quantum sub-circuit module, and the measurement operation module to obtain the differentiable quantum circuit.

In another implementation of this application, the step of predicting a target solution of the differential equation based on a variational parameter in the differentiable quantum circuit includes: updating the variational parameter by using an optimization algorithm, and predicting the target solution of the differential equation based on the updated variational parameter.

In another implementation of this application, the updating the variational parameter by using an optimization algorithm includes: updating the variational parameter θ by using the following equation: θⁿ⁺¹=θⁿ−α∇_{θ}L, where n is an integer not less than 1, α is a learning rate, L is a loss function, and ∇θ is a gradient of the loss function with respect to θ.

In another implementation of this application, the loss function is as follows:

$${L}_{θ} [ {d}_{x} f , f , x ] = {L}_{θ}^{( diff )} [ {d}_{x} f , f , x ] + {L}_{θ}^{( boundary )} [ f , x ] + {L}_{θ}^{reg} [ f , x ]$$

where L_{θ}^{(diff)} denotes an error generated when the predicted solution of the differential equation does not satisfy the differential equation, dₓƒ denotes a derivative term in the differential equation, ƒ denotes a function corresponding to the differential equation, x denotes a variable, L_{θ}^{(boundary)} denotes an error generated when the predicted solution of the differential equation does not satisfy the boundary condition and the initial condition, and

$${L}_{θ}^{reg} [ f , x ]$$

denotes an error of a regular term.

In another implementation of this application, the differential equation is a time-dependent partial differential equation, and the steps of predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result include: predicting a target solution of the time-dependent partial differential equation based on an initial variational parameter of the differentiable quantum circuit, and in a case that a value of a loss function at a current time constructed based on the predicted processing result obtained through the prediction satisfies the specified accuracy condition, using a predicted solution, obtained when the value of the loss function satisfies the specified accuracy condition, of the time-dependent partial differential equation as the target solution of the time-dependent partial differential equation.

In another implementation of this application, the time-dependent partial differential equation includes:

$$\frac{\partial u ( x , t )}{\partial t} + {N}^{′} [ u ( x , t ) ] = 0 , x ∈ Ω , t ∈ [ 0 , T ]$$

where u(x,t) is a solution of the time-dependent partial differential equation, x is a spatial variable, t is a time variable, N′[u(x, t)] is a nonlinear term, Ω is a computational domain, and T is a time.

In another implementation of this application, the data of the data processing task further includes an initial condition and a boundary condition of the time-dependent partial differential equation. After the step of acquiring data of a data processing task, the method further includes: determining the time-dependent partial differential equation expressed in a semi-discrete format based on a pre-selected difference scheme.

In another implementation of this application, the pre-selected difference scheme is an implicit difference scheme; and the step of determining the time-dependent partial differential equation expressed in a semi-discrete format based on a pre-selected difference scheme includes: determining the time-dependent partial differential equation expressed in a semi-discrete format as:
u(x, t+Δt)=u(x, t)+Δt·N′[u(x, t+Δt)], where u(x, t+Δt) is a solution of the time-dependent partial differential equation at time t+Δt.

In another implementation of this application, the predicting a target solution of the time-dependent partial differential equation based on the initial variational parameter of the differentiable quantum circuit includes: acquiring a set of qubits and setting an initial state of the qubits to |0 [symbol] ; constructing, by using a first type of quantum logic gates, a first quantum sub-circuit module for generating a function space basis set; acquiring the initial variational parameter and constructing, by using a second type of quantum logic gates, a second quantum sub-circuit module for combining the function space basis set into a predicted solution of the time-dependent partial differential equation; constructing a measurement operation module for obtaining the predicted solution of the time-dependent partial differential equation; and sequentially combining the first quantum sub-circuit module, the second quantum sub-circuit module, and the measurement operation module to construct the differentiable quantum circuit, and determining the predicted solution of the time-dependent partial differential equation based on an acquired final quantum state corresponding to the initial variational parameter.

In another implementation of this application, the determining the predicted solution of the time-dependent partial differential equation includes: acquiring a pre-selected measurement operator; determining an expected value corresponding to the measurement operator based on the final quantum state; and determining the predicted solution of the time-dependent partial differential equation based on the expected value.

In another implementation of this application, the first type of quantum logic gates includes an Rx quantum logic gate, an Ry quantum logic gate, and an Rz quantum logic gate; and the second type of quantum logic gates includes an Rx quantum logic gate, an Ry quantum logic gate, an Rz quantum logic gate, and a CNOT quantum logic gate.

In another implementation of this application, the loss function at the current time constructed based on the predicted processing result obtained through the prediction includes: if the current time is an initial time, a loss function at the initial time is as follows:

$${L}_{θ} ( 0 ) = \frac{1}{{N}^{′}} {\sum }_{i = 1}^{{N}^{′}} {[ \tilde{u} ( {x}_{i} , 0 ) - g ( {x}_{i} ) ]}^{2} + \frac{1}{M} {\sum }_{{j}^{′} = 1}^{M} {[ \tilde{u} ( {x}_{{j}^{′}} , 0 ) - h ( {x}_{{j}^{′}} , 0 ) ]}^{2}$$

where N′ is a quantity of discrete points, M is a quantity of boundary points, i is the i^{th} discrete point, j′ is the j′^{th} boundary point, ũ(xᵢ, 0) is a predicted processing result at the initial time, g(xᵢ) is an initial condition, and h(xⱼ′,0) is a boundary condition at the initial time; if the current time is time Δt, a loss function at time Δt is as follows:

$$\begin{matrix}{L}_{θ} ( Δ t ) = \frac{1}{{N}^{′}} {\sum }_{i = 1}^{{N}^{′}} {[ \tilde{u} ( {x}_{i} , Δ t ) - \tilde{u} ( {x}_{i} , 0 ) - Δ t \cdot {N}^{′} [ \tilde{u} ( {x}_{i} , Δ t ] ]}^{2} \\ + \frac{1}{M} {\sum }_{{j}^{′} = 1}^{M} {[ \tilde{u} ( {x}_{{j}^{′}} , Δ t ) - h ( {x}_{{j}^{′}} , Δ t ) ]}^{2}\end{matrix}$$

where N′[u(x, t)] is determined based on a differentiable quantum circuit at a previous time.

In another implementation of this application, the method further includes: updating the variational parameter θ by using the following equation: θⁿ⁺¹=θⁿ−α∇_{θ}L, where n is an integer not less than 1, α is a learning rate, L is a loss function, and ∇θ is a gradient of the loss function with respect to θ.

In another implementation of this application, after the step of acquiring data of a data processing task, the method further includes: acquiring a computational domain of the differential equation and dividing the computational domain into a plurality of mutually non-overlapping computational sub-domains. The step of constructing a differentiable quantum circuit based on the data of the data processing task includes: constructing differentiable quantum circuits corresponding to the computational sub-domains, where one computational sub-domain corresponds to one predicted solution of the differential equation. The steps of predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result include: predicting a target solution of the differential equation based on the differentiable quantum circuits, and in a case that a value of a union loss function, constructed based on predicted solutions of the differential equation, of the computational sub-domains satisfies the specified accuracy condition, using the predicted solutions, obtained when the value of the loss function satisfies the specified accuracy condition, of the differential equation as the target solution of the differential equation.

In another implementation of this application, the differential equation is as follows:

$$\{ \begin{matrix}F ( {d}_{x} u , u , x ) = 0 \\ u ( {x}_{0} ) = {u}_{0}\end{matrix}$$

where F is a functional, dₓu is a derivative term, u is a solution of the differential equation, and x is a variable.

In another implementation of this application, the predicting a target processing result of the data processing task based on the differentiable quantum circuits includes: predicting a target solution of the differential equation based on a variational parameter in the differentiable quantum circuits.

In another implementation of this application, the step of constructing differentiable quantum circuits corresponding to the computational sub-domains includes: acquiring a set of qubits and setting an initial state of the qubits to |0 [symbol] ; constructing, by using a first type of quantum logic gates, a first quantum sub-circuit module for generating a function space basis set; constructing, by using a second type of quantum logic gates, a second quantum sub-circuit module for combining the function space basis set into a predicted solution of the differential equation; constructing a measurement operation module for obtaining the predicted solution of the differential equation; and sequentially combining the first quantum sub-circuit module, the second quantum sub-circuit module, and the measurement operation module to construct each of the differentiable quantum circuits.

In another implementation of this application, the step of predicting a target solution of the differential equation based on a variational parameter in the differentiable quantum circuits includes: acquiring a pre-selected measurement operator; determining an expected value corresponding to the measurement operator based on a final quantum state corresponding to the variational parameter in the differentiable quantum circuits; and determining the predicted solution of the differential equation based on the expected value.

In another implementation of this application, the first type of quantum logic gates includes an Rx quantum logic gate, an Ry quantum logic gate, and an Rz quantum logic gate; and the second type of quantum logic gates includes an Rx quantum logic gate, an Ry quantum logic gate, an Rz quantum logic gate, and a CNOT quantum logic gate.

In another implementation of this application, the union loss function is as follows:

$${L}_{θ} ( 0 ) = {\sum }_{i = 1}^{n} {L}_{i}^{( diff )} [ {d}_{x} {f}_{i} , {f}_{i} , x ] + {\sum }_{i = 1}^{n} {L}_{i}^{( boundary )} [ {f}_{i} , x ] + {\sum }_{i = 1}^{{n}_{b}} {L}_{i}^{( interface )} [ f , x ]$$

where n is a quantity of computational sub-domains, n_{b} is a quantity of interfaces, Lᵢ^{(diff)} [dₓƒᵢ, ƒᵢ, x] is an error caused when a predicted solution of the differential equation corresponding to the i^{th} computational sub-domain does not satisfy the differential equation, Lᵢ^{(boundary)}[ƒᵢ, x] is an error caused when a predicted solution of the differential equation corresponding to the i^{th} computational sub-domain does not satisfy a boundary condition satisfied by a solution of the differential equation, Lᵢ^{(interface)} [ƒ,x] is an error caused when predicted solutions of the differential equation corresponding to adjacent computational sub-domains on two sides of the i^{th} interface do not satisfy an interface continuity condition and

$${L}_{i}^{( interface )} [ f , x ] = \frac{1}{{n}_{i}} {\sum }_{j = 1}^{{n}_{i}} {( {f}^{+} ( {x}_{j} ) - {f}^{-} ( {x}_{j} ) )}^{2} ,$$

nᵢ is a quantity of discrete points on the i^{th} interface, and ƒ⁺(xⱼ) and ƒ⁻(xⱼ) are the predicted solutions of the differential equation corresponding to computational sub-domains on two sides of the interface.

In another implementation of this application, the step of predicting a target solution of the differential equation based on a variational parameter in the differentiable quantum circuits includes: updating the variational parameter in the differentiable quantum circuits by using an optimization algorithm; and obtaining an updated predicted solution of the differential equation based on the updated variational parameter in the differentiable quantum circuits.

In another implementation of this application, the step of updating the variational parameter in the differentiable quantum circuits by using an optimization algorithm includes:
updating the variational parameter θ by using the following equation: θⁿ⁺¹=θⁿ−α∇_{θ}L, where n is an integer not less than 1, α is a learning rate, L is the union loss function, and ∇θ is a gradient of the union loss function with respect to θ.

In another implementation of this application, the data of the data processing task further includes a derivative term of the differential equation. The step of constructing a differentiable quantum circuit based on the data of the data processing task includes: constructing differentiable quantum circuits respectively based on the differential equation and the derivative term of the differential equation. The steps of predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result include: predicting a target solution of the differential equation and a value of the derivative term of the differential equation based on the differentiable quantum circuits, and in a case that a value of a loss function constructed based on a predicted solution of the differential equation and a predicted value of the derivative term of the differential equation satisfies the specified accuracy condition, using the predicted solution, obtained when the value of the loss function satisfies the specified accuracy condition, of the differential equation as the target solution of the differential equation.

In another implementation of this application, the differential equation is as follows:

$$\{ \begin{matrix}F ( {d}_{x} u , u , x ) = 0 \\ u ( {x}_{0} ) = {u}_{0}\end{matrix}$$

where F is a functional, dₓu is a derivative term of the differential equation, u is a predicted solution of the differential equation, and x is a variable.

In another implementation of this application, the step of constructing differentiable quantum circuits respectively based on the differential equation and the derivative term of the differential equation includes: respectively constructing differentiable quantum circuits for solving a predicted solution of the differential equation and for solving the predicted value of the derivative term of the differential equation, and determining the predicted solution of the differential equation and the predicted value of the derivative term of the differential equation that are corresponding to variational parameters in the differentiable quantum circuits respectively.

In another implementation of this application, the respectively constructing differentiable quantum circuits for solving the predicted solution of the differential equation and for solving the predicted value of the derivative term of the differential equation includes: separately acquiring a set of qubits and setting an initial state of the qubits to |0 [symbol] ; separately constructing, by using a first type of quantum logic gates, a first quantum sub-circuit module for generating a function space basis set; constructing, by using a second type of quantum logic gates, second quantum sub-circuit modules for combining function space basis sets into the predicted solution of the differential equation and the predicted value of the derivative term of the differential equation respectively; respectively constructing measurement operation modules for obtaining the predicted solution of the differential equation and the predicted value of the derivative term of the differential equation, and separately combining the first quantum sub-circuit module, the second quantum sub-circuit module, and the measurement operation module to construct the differentiable quantum circuit.

In another implementation of this application, the determining the predicted solution of the differential equation and the predicted value of the derivative term of the differential equation that are corresponding to a variational parameter in the differentiable quantum circuits respectively includes: acquiring a pre-selected measurement operator; separately determining an expected value corresponding to the measurement operator based on a final quantum state corresponding to the variational parameter in the differentiable quantum circuit; and determining the predicted solution of the differential equation and the predicted value of the derivative term of the differential equation based on the respective expected values.

In another implementation of this application, the loss function is as follows:

L[ƒⁱ, ƒ, x]=L^{(diff)} [ƒⁱ, ƒ, x]+L^{(boundary)} [ƒ, x], where ƒᵢ denotes the i^{th} order derivative term in the differential equation, L^{(diff)} denotes an error generated when the predicted solution of the differential equation does not satisfy the differential equation, ƒ denotes the differential equation, x denotes a variable, and L^{(boundary)} denotes an error generated when the predicted solution of the differential equation does not satisfy a boundary condition and an initial condition of the solution of the differential equation.

In another implementation of this application, the determining the predicted solution of the differential equation and the predicted value of the derivative term of the differential equation that are corresponding to a variational parameter in the differentiable quantum circuits respectively includes: separately updating the variational parameter in the differentiable quantum circuit by using an optimization algorithm; and obtaining an updated predicted solution of the differential equation and an updated predicted value of the derivative term of the differential equation based on the updated variational parameters in the differentiable quantum circuits respectively.

In another implementation of this application, the step of updating the variational parameter in the differentiable quantum circuit by using an optimization algorithm includes: updating the variational parameter θ by using the following equation: θⁿ⁺¹=θⁿ−α∇_{θ}L, where n is an integer not less than 1, α is a learning rate, L is the loss function, and ∇θ is a gradient of the loss function with respect to θ.

An implementation of this application provides an apparatus for processing a data processing task, and the apparatus includes:
an acquisition module, configured to acquire data of a data processing task, where the data processing task is a task to solve a differential equation; and the data of the data processing task includes the differential equation;
a construction module, configured to construct a differentiable quantum circuit based on the data of the data processing task; and
a prediction module, configured to predict a target processing result of the data processing task based on the differentiable quantum circuit; and in a case that a value of a loss function constructed based on a predicted processing result obtained through the prediction satisfies a specified accuracy condition, use the predicted processing result obtained when the value of the loss function satisfies the specified accuracy condition as the target processing result.

Another implementation of this application provides a non-transitory computer-readable storage medium. The non-transitory computer-readable storage medium stores a computer program. When the computer program is run, the method according to any one of the foregoing implementations is performed.

Another implementation of this application provides an electronic apparatus, including a memory and a processor. The memory stores a computer program. When the processor is configured to run the computer program, the method according to any one of the foregoing implementations is performed.

Compared with the related technology, in the present application, data of a data processing task is acquired, a differentiable quantum circuit is constructed based on the data of the data processing task, a target processing result of the data processing task is predicted based on the differentiable quantum circuit, and in a case that a value of a loss function constructed based on a predicted processing result obtained through the prediction satisfies a specified accuracy condition, the predicted processing result obtained when the value of the loss function satisfies the specified accuracy condition is used as the target processing result. In this way, the loss function can be constructed based on the predicted processing result, and a solution of the differential equation can be implemented by updating a value of the loss function, so as to reduce resource consumption caused by grid division.

### BRIEF DESCRIPTION OF THE DRAWINGS

To describe the technical solutions in implementations of this application or the related technologies more clearly, the accompanying drawings required for describing the implementations or the related technologies are briefly described below. Apparently, the accompanying drawings in the following description show merely some implementations of this application, and therefore should not be taken as limiting the scope. A person of ordinary skill in the art may still derive other drawings from these accompanying drawings without creative efforts.

FIG. 1 is a block diagram of a hardware structure of a computer terminal to which a method for processing a data processing task is applied according to an implementation of this application.

FIG. 2 is a schematic flowchart of a method for processing a data processing task according to an implementation of this application.

FIG. 3 is a schematic diagram of a differentiable quantum circuit according to an implementation of this application.

FIG. 4 is a schematic diagram of another differentiable quantum circuit according to an implementation of this application.

FIG. 5 is a schematic flowchart of another method for processing a data processing task according to an implementation of this application.

FIG. 6 is a schematic flowchart of another method for processing a data processing task according to an implementation of this application.

FIG. 7 is a schematic diagram of division of a computational domain according to an implementation of this application.

FIG. 8 is a schematic diagram of another differentiable quantum circuit according to an implementation of this application.

FIG. 9 is a schematic flowchart of another method for processing a data processing task according to an implementation of this application.

FIG. 10 is a schematic structural diagram of an apparatus for processing a data processing task according to an implementation of this application.

### DETAILED DESCRIPTION OF THE EMBODIMENTS

Embodiments described below with reference to the accompanying drawings are exemplary and merely used to explain the present application, but cannot be understood as a limitation on the present application.

An implementation of this application provides a method for processing a data processing task. The method may be applied to an electronic device, for example, a computer terminal, specifically, a common computer, or a quantum computer, or the like.

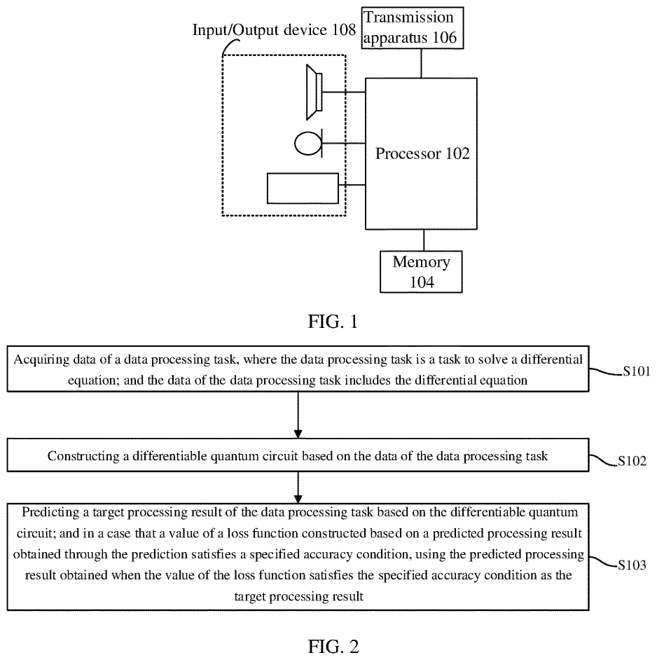

The following describes the method in detail by using an example in which the method is run on a computer terminal. FIG. 1 is a block diagram of a hardware structure of a computer terminal to which a method for processing a data processing task is applied according to an implementation of this application. As shown in FIG. 1, the computer terminal may include one or more (only one is shown in FIG. 1) processors 102 and a memory 104 configured to store data, where the processors 102 may include, but are not limited to, a processing apparatus such as a microcontroller unit (Microcontroller Unit, MCU) or a programmable gate array (Field Programmable Gate Array, FPGA). In some implementations, the computer terminal may further include a transmission apparatus 106 and an input/output device 108 for implementing a communications function. A person of ordinary skill in the art may understand that the structure shown in FIG. 1 is merely an example and does not constitute any limitation on a structure of the computer terminal. For example, the computer terminal may alternatively include more or fewer components than those shown in FIG. 1, or have a configuration different from that shown in FIG. 1.

The memory 104 may be configured to store a software program and a software module of application software, for example, program instructions/modules corresponding to the method for processing a data processing task in implementations of this application. By running the software program and the software module stored in the memory 104, the processor 102 executes various functional applications and data processing, that is, implements the foregoing method. The memory 104 may include a high-speed random access memory, and may further include a non-volatile memory, for example, one or more disk storage apparatus, a flash memory, or another non-volatile solid-state memory. In some embodiments, the memory 104 may further include a memory remotely disposed relative to the processor 102, which may be connected to a computer terminal over a network. Examples of the network include but are not limited to the Internet, a corporate intranet, a local area network, a mobile communication network, and a combination thereof.

The transmission apparatus 106 is configured to receive or send data over a network. A specific example of the network may include a wireless network provided by a communication provider of a computer terminal. In an example, the transmission apparatus 106 includes a network interface controller (Network Interface Controller, NIC). The network interface controller may be connected to another network device through a base station to communicate with the Internet. In an example, the transmission apparatus 106 may be a radio frequency (Radio Frequency, RF) module. The radio frequency module is configured to communicate with the Internet in a wireless manner.

It should be noted that a real quantum computer is a hybrid structure that includes two main parts: One is a classical computer responsible for classical computation and control. The other is a quantum device responsible for running quantum programs to implement quantum computation. The quantum program is an instruction sequence that is written in a quantum language such as the QRunes language and that may be run on the quantum computer. In this way, quantum logic gate operations are supported, and ultimately quantum computation is implemented. Specifically, the quantum program is an instruction sequence through which quantum logic gates are operated in a specific time sequence.

In actual application, limited by the development of hardware of a quantum device, quantum computation simulation often needs to be performed to verify a quantum algorithm, quantum application, and the like. The quantum computation simulation is a process in which virtual architecture (that is, a quantum virtual machine) built by using resources of a common computer realizes simulation of running a quantum program corresponding to a specific problem. Generally, the quantum program corresponding to the specific problem needs to be constructed. The quantum program in implementations of this application is a program that is written in a classical language and that indicates qubits and their evolution. Herein, qubits, quantum logic gates, and the like related to quantum computation are all represented by corresponding classical code.

The quantum circuit, as an embodiment of the quantum program, is also referred to as a quantum logic circuit and is the most commonly used general quantum computation model. The quantum circuit is a circuit that operates qubits from an abstract concept, and includes qubits, lines (timelines), and various quantum logic gates. Finally, a result usually needs to be read through a quantum measurement operation.

A conventional circuit is connected through metallic wires to transmit voltage signals or current signals. Different from the conventional circuit, the quantum circuit may be considered to be connected by time. To be specific, a state of a qubit evolves naturally with time. This process proceeds according to an instruction of the Hamiltonian operator until the qubit is operated by a logic gate.

One quantum program as a whole corresponds to one total quantum circuit. The quantum program in this application indicates the total quantum circuit. A total quantity of qubits in the total quantum circuit is the same as a total quantity of qubits in the quantum program. It may be understood that one quantum program may include a quantum circuit, a measurement operation for qubits in the quantum circuit, a register for saving a measurement result, and a control flow node (a jump instruction), and one quantum circuit may include tens of or hundreds of or even thousands of quantum logic gate operations. An execution process of the quantum program is a process of executing all quantum logic gates in a specific time sequence. It should be noted that the time sequence is a sequence of time at which an individual quantum logic gate is executed.

It should be noted that in classical computation, the most basic unit is a bit, and the most basic control mode is a logic gate. A purpose of controlling a circuit may be achieved through a combination of logic gates. Similarly, a manner of processing the qubit is to use the quantum logic gate. The use of the quantum logic gate enables the evolution of a quantum state. The quantum logic gate is a base for forming the quantum circuit. The quantum logic gate includes single-bit quantum logic gates such as the Hadamard gate (H gate, Hadamard gate), the Pauli-X gate (X gate), the Pauli-Y gate (Y gate), the Pauli-Z gate (Z gate), the RX gate, the RY gate, and the RZ gate; and multi-bit quantum logic gates such as the CNOT gate, the CR gate, the iSWAP gate, or the Toffoli gate. The quantum logic gate is generally represented by using a unitary matrix. The unitary matrix is not only a matrix form but also an operation and a transform. Generally, an action of the quantum logic gate on a quantum state is calculated by left multiplying a unitary matrix by a matrix corresponding to a quantum state ket.

A person skilled in the art may understand that, in a classic computer, a basic unit of information is a bit, and one bit has two states, namely, 0 and 1. The most common physical implementation is to express the two states by levels. In quantum computation, a basic unit of information is a qubit, and one qubit also has two states of 0 and 1, which are recorded as |0 [symbol] and |1 [symbol] . However, the qubit may be in a superposition state of the two states of 0 and 1, which may be expressed as |φ [symbol] =a|0 [symbol] +b|1 [symbol] , where a and b are complex numbers expressing an amplitude (a probability amplitude) of the state |0 [symbol] and the state |1 [symbol] , which is not contained in a bit in the classic computer. After measurement, the states of the qubit collapses to a specific state (eigenstate, namely state |0 [symbol] and state |1 [symbol] herein), where a probability of collapsing to state |0 [symbol] is |a|², a probability of collapsing to state |1 [symbol] is |b|², |a|²+|b|²=1, and | [symbol] is a Dirac notation.

A quantum state refers to a state of a qubit, and an eigenstate thereof is represented by using a binary in a quantum algorithm (or referred to as a quantum program). For example, a set of qubits are q0, q1, and q2, representing qubits in the order of the 0^{th} bit, the 1^{st} bit, and the 2^{nd} bit, and the qubits are ordered from a high bit to a low bit as q2q1q0. Quantum states of the set of qubits is a superposition state of 2³ eigenstates, and 8 eigenstates (determined states) are: |000 [symbol] , |001 [symbol] , |010 [symbol] , |011 [symbol] , |100 [symbol] , |101 [symbol] , |110 [symbol] , and |111 [symbol] . Each eigenstate corresponds to a qubit, for example, for the state |000 [symbol] , 000 corresponds to q2q1q0 from a high bit to a low bit. In short, quantum states are a superposition state composed of eigenstates. When a probability amplitude of another state is 0, a qubit is in one of the determined eigenstates. In a related technology, solving a hydrodynamic problem by using a numerical method generally relates to solving a differential equation, and in many scientific technical fields, the solving of the differential equation is involved. Therefore, it is crucial to develop an effective method for solving a differential equation.

It may be understood that, whether solving a differential equation by using a classical computer or a quantum computer, is implemented in a manner of obtaining a processing result of a data processing task by establishing the data processing task and executing a processing process of the data processing task.

This application proposes a method for processing a data processing task. The data processing task includes solving a general differential equation (including but not limited to a partial differential equation including a time term), to solve a problem of high consumption of resources in numerical discrete for a spatial derivative in a case of a complex computational domain shape, and a utilization rate of existing prior data may be further improved.

Referring to FIG. 2, FIG. 2 is a schematic flowchart of a method for processing a data processing task according to an implementation of this application, and the method may include the following steps.

S101: Acquiring data of a data processing task, where the data processing task is a task to solve a differential equation; and the data of the data processing task includes the differential equation.

Specifically, any equation that represents a relationship between an unknown function, a derivative of the unknown function, and an independent variable is referred to as a differential equation. If the unknown function is a function of one variable, the differential equation is called an ordinary differential equation; if the unknown function is a function of multiple variables and the differential equation includes a derivative of the unknown function, differential equation is called a partial differential equation, for example,

$$\frac{dy}{dx} = x$$

$$and$$

$$\frac{ds}{dt} = 1$$

are all differential equations. For example, the data processing task may include solving the following differential equations:

$$\{ \begin{matrix}\frac{du}{dx} + u \cdot tan x = {x}^{2} \\ u ( {x}_{0} ) = {u}_{0}\end{matrix}$$

Where u is a data processing result of the data processing task, namely, a solution of the differential equation, and x is a variable.

S102: Constructing a differentiable quantum circuit based on the data of the data processing task.

Specifically, to clearly illustrate ideas of the technical solutions in this application, the following first describes the differentiable quantum circuit in detail, and then describes the technical solutions on this basis. The constructing a differentiable quantum circuit may include the following steps.
Step 1: Acquiring a set of qubits and setting an initial state of the qubits to |0 [symbol] .
Step 2: Constructing, by using a first type of quantum logic gates, a first quantum sub-circuit module for generating a function space basis set.

Specifically, the first quantum sub-circuit module for acquiring the function space basis set is constructed by using the first type of quantum logic gates, and the first quantum sub-circuit module is configured to convert a predefined nonlinear function φ(x) into a quantum state amplitude û_{φ}(x)|0 [symbol] of an initial state, which is used as a function space basis set, where

$${\hat{u}}_{φ} ( x ) = {⊗}_{j}^{N} {\hat{R}}_{y , j} ( φ [ x ] ) ,$$

N is a quantity of qubits, j is a sequence number of the qubits, and \hat{R}_{y,j} is an Ry quantum logic gate on the j^{th} qubit.

For example, it is assumed that a predefined non-linear function is φ(x)=2n arccos x, which is substituted into \hat{R}_{y,j}(φ[x]), formulas are obtained as follows:

$$\begin{matrix}{\hat{R}}_{y , j} ( φ [ x ] ) = exp ( - i \frac{2 n arc cos x}{2} {\hat{Y}}_{j} ) = cos ( n arc cos x ) {1}_{j} - i sin ( n arc cos x ) {\hat{Y}}_{j} \\ = {T}_{n} ( x ) {1}_{j} + \sqrt{1 - {x}^{2}} {U}_{n - 1} ( x ) {\hat{X}}_{j} {\hat{Z}}_{j}\end{matrix}$$

Where Tₙ(x) and Uₙ(x) are Chebyshev polynomials of the first kind and second kind of degree n, respectively, and have three crucial properties, namely, linkage, nesting, and differentiability. These properties greatly enhance a representation capability of a Chebyshev polynomial basis set. Details are as follows:

2Tₙ(x)Tₘ(x)=Tₘ₊ₙ(x)+T_{|m-n|}(x) Linkage:

Tₙ(Tₘ(x))=Tₘₙ(x) Nesting:

Differentiability:

$$\frac{{dT}_{n} ( x )}{dx} = {nU}_{n - 1} ( x )$$

A relevant approximation theory indicates that any smooth function ƒ(x) may be expressed as

$$f ( x ) = {\sum }_{n = 0}^{∞} {A}_{n} {T}_{n} ( x ) .$$

The first type of quantum logic gates may include an Rx quantum logic gate, an Ry quantum logic gate, and an Rz quantum logic gate.
Step 3: Constructing, by using a second type of quantum logic gates, a second quantum sub-circuit module for combining the function space basis set into a predicted solution of the differential equation.

Specifically, the second quantum sub-circuit module configured to combine the function space basis set into the predicted solution of the differential equation is constructed by using the second type of quantum logic gates, to convert the quantum state amplitude û_{φ}(x)|0 [symbol] of the initial state into a final quantum state |ƒ_{φ, θ}(x) [symbol] , and solve the predicted solution of the differential equation based on the final quantum state, where |ƒ_{φ, θ}(x) [symbol] =û_{θ}û_{φ}(x)|0 [symbol] , and û_{θ} is a unitary matrix corresponding to the second quantum sub-circuit module.

The second quantum sub-circuit may include but is not limited to a hardware efficient ansatz (Hardware Efficient Ansatz, HEA) circuit and an alternating blocks ansatz (Alternating Blocks Ansatz, ABA) circuit. The HEA circuit includes a single-quantum-rotated connection layer and a global entanglement layer. As a quantity of layers is deepened, a circuit expression capability is continuously improved, and training difficulty of the circuit is also increased. Unlike the HEA circuit, the ABA circuit does not use the global entanglement layer, but splits the circuit into a plurality of sub-blocks and uses a circuit in the HEA form in the sub-blocks. In other words, the ABA circuit first establishes local entanglement and then gradually forms a related state through interleaved sub-blocks, which helps to improve trainability of the circuit, maintain a high expression capability, and prevent occurrence of gradient vanishing during an iteration process.

The second type of quantum logic gates may include an Rx quantum logic gate, an Ry quantum logic gate, an Rz quantum logic gate, and a CNOT quantum logic gate.
Step 4: Constructing a measurement operation module for obtaining the predicted solution of the differential equation.

Specifically, the measurement operation module acting on a qubit is constructed to measure a final quantum state of the qubit.
Step 5: Sequentially combining the first quantum sub-circuit module, the second quantum sub-circuit module, and the measurement operation module to obtain the differentiable quantum circuit.

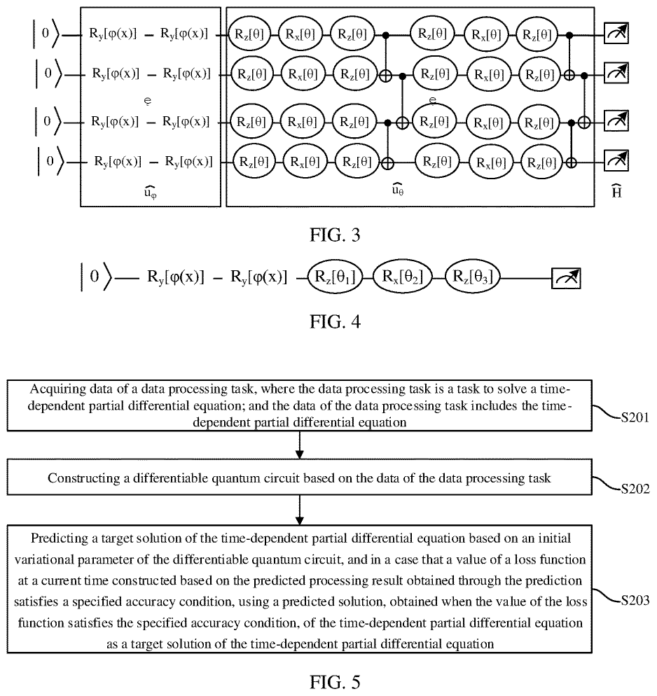

Specifically, the first quantum sub-circuit module, the second quantum sub-circuit module, and the measurement operation module are sequentially combined to construct a schematic diagram of a differentiable quantum circuit shown in FIG. 3. A black dot and an icon ⊕ in the figure represent a CNOT quantum logic gate, where the black dot is on a control bit of the CNOT quantum logic gate, and the icon ⊕ is on a target bit of the CNOT quantum logic gate.

After a first quantum sub-circuit and a second quantum sub-circuit pass through, information of a quantum circuit needs to be read out, and a final quantum state corresponding to a variational parameter needs to be obtained.

S103: Predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result.

The predicting a target processing result of the data processing task based on the differentiable quantum circuit may include the following steps.
Step 1: Acquiring information of a to-be-solved differential equation as well as an initial condition and a boundary condition that are satisfied by a solution of the to-be-solved differential equation.

Specifically, there are generally a plurality of solutions to the differential equation. However, when a specific physical problem is to be solved, a required solution needs to be selected from the solutions. Therefore, an additional condition, namely, the initial condition and the boundary condition also need to be known. Following the above example, where u(x₀)=u₀ may be used as the initial condition or the boundary condition.
Step 2: Constructing a differentiable quantum circuit and determining a variational parameter in the differentiable quantum circuit.
Step 3: Predicting a solution of the differential equation by using the differentiable quantum circuit according to the initial condition and the boundary condition.

Specifically, the predicting a solution of the differential equation by using the differentiable quantum circuit may include the following steps.

a. Acquiring a Pre-Selected Measurement Operator.

After the foregoing differentiable quantum circuit passes through, a final state |ƒ_{φ, θ}(x) [symbol] =û_{θ}û_{φ}(x)|0 [symbol] is obtained. To read out quantum state information, a measurement operator Ĥ needs to be used to measure the final state to obtain the predicted solution f(x)= [symbol] ƒ_{φ, θ}(x)|Ĥ|f_{φ, θ}(x) [symbol] of the differential equation. A key of this process is to select the measurement operator Ĥ in advance, and it may select, but not limited to, magnetization of an entire system as the measurement operator Ĥ, that is, Ĥ=Σⱼ \hat{Z}ⱼ, where Z is a Pauline operator. In addition, the Ising Hamiltonian with additional transverse and longitudinal magnetic fields may alternatively be selected as the measurement operator.

b. Determining, Based on the Final Quantum State, an Expected Value Corresponding to the Measurement Operator.

Specifically, the expected value ƒ_{φ, θ}(x) corresponding to the measurement operator Ĥ is determined based on the final quantum state |ƒ_{φ, θ}(x) [symbol] , where the expected value f_{φ, θ}(x)= [symbol] f_{φ, θ}(x)|Ĥ|f_{φ, θ}(x) [symbol] .

c. Determining the Predicted Solution of the Differential Equation Based on the Expected Value.

Specifically, the expected value ƒ_{φ, θ}(x) is determined as the predicted solution ƒ(x) of the differential equation.

For example, for convenience of description, solving of the foregoing differential equation is demonstrated by using a circuit with only one qubit. A schematic diagram of another differentiable quantum circuit shown in FIG. 4 is constructed. A measurement operator Ĥ=Z is used, and after a measurement operation, an output result of the quantum circuit is the predicted solution ƒ(x).

When a predefined non-linear function φ(x)=arccos x is used, an expression of a function space basis set generated based on the first quantum sub-circuit is as follows:

$${u}_{φ} ( x ) = ( \begin{matrix}2 {x}^{2} - 1 & - 2 x \sqrt{1 - {x}^{2}} \\ 2 x \sqrt{1 - {x}^{2}} & 2 {x}^{2} - 1\end{matrix} )$$

A second quantum sub-circuit for combining the function space basis set into a predicted solution of the differential equation is constructed by using Rx gate and Rz gate, and an expression of combining the function space basis set into the predicted solution of the differential equation according to the second quantum sub-circuit is as follows:

$${u}_{θ} = ( \begin{matrix}{e}^{- \frac{1}{2} i ( {θ}_{1} + {θ}_{3} )} cos [ \frac{{θ}_{2}}{2} ] & - {ie}^{\frac{1}{2} i ( {θ}_{1} - {θ}_{3} )} sin [ \frac{{θ}_{2}}{2} ] \\ - {ie}^{- \frac{1}{2} i ( {θ}_{1} - {θ}_{3} )} sin [ \frac{{θ}_{2}}{2} ] & {e}^{\frac{1}{2} i ( {θ}_{1} + {θ}_{3} )} cos [ \frac{{θ}_{2}}{2} ]\end{matrix} )$$

Therefore, the final quantum state is as follows:

$$\vert {f}_{φ , θ} ( x ) 〉 = ( \begin{matrix}{e}^{- \frac{1}{2} i ( {θ}_{1} + {θ}_{3} )} ( ( 2 {x}^{2} - 1 ) cos ( \frac{{θ}_{2}}{2} ) - 2 {ie}^{i {θ}_{1}} x \sqrt{1 - {x}^{2}} sin ( \frac{{θ}_{2}}{2} ) ) \\ {e}^{- \frac{1}{2} i ( {θ}_{1} - {θ}_{3} )} ( i ( 1 - 2 {x}^{2} ) sin ( \frac{{θ}_{2}}{2} ) + 2 {e}^{i {θ}_{1}} x \sqrt{1 - {x}^{2}} cos ( \frac{{θ}_{2}}{2} ) )\end{matrix} )$$

After a measurement operation is performed by using the measurement operation module, an output result of the quantum circuit, namely, the predicted solution ƒ(x), is as follows:

$$f ( x ) = ( 1 + 4 {x}^{4} - 4 {x}^{2} ( 1 + \sqrt{{( - 1 + {x}^{2} )}^{2}} ) ) cos [ {θ}_{2} ] + 4 {x ( {x}^{2} - 1 )}^{\frac{1}{2}} ( - 1 + 2 {x}^{2} ) sin [ {θ}_{1} ] sin [ {θ}_{2} ]$$

The constructing a loss function based on a predicted processing result obtained through the prediction may include:
constructing a loss function expressed in a form as follows:

$${L}_{θ} [ {d}_{x} f , f , x ] = {L}_{θ}^{( diff )} [ {d}_{x} f , f , x ] + {L}_{θ}^{( boundary )} [ f , x ] + {L}_{θ}^{reg} [ f , x ]$$

Where L_{θ}^{(diff)} denotes an error generated when the predicted processing result does not satisfy the differential equation, dₓƒ denotes a derivative term in the differential equation, ƒ denotes a function to be solved of the differential equation, x denotes a variable, L_{θ}^{(boundary)} denotes an error generated when the predicted processing result does not satisfy a boundary condition and an initial condition, and

$${L}_{θ}^{reg} [ f , x ]$$

denotes an error of a regular term.

For example, in the foregoing example, ƒ(x) is the predicted processing result obtained by predicting the differential equation. In an initial stage, because the predicted processing result does not satisfy the differential equation and the initial condition, a loss function is generated as follows:

$${L}_{θ} [ {d}_{x} f , f , x ] = {L}_{θ}^{( diff )} [ {d}_{x} f , f , x ] + {L}_{θ}^{( boundary )} [ f , x ] + {L}_{θ}^{reg} [ f , x ]$$

Where

$${L}_{θ}^{( diff )} [ {d}_{x} f , f , x ] = \frac{1}{N} {\sum }_{i = 1}^{N} {F [ {d}_{x} f ( {x}_{i} ) , f ( {x}_{i} ) , {x}_{i} ]}^{2}$$

$${L}_{θ}^{( boundary )} [ f , x ] = {( f ( {x}_{0} ) - {u}_{0} )}^{2}$$

$${L}_{θ}^{reg} [ f , x ] = \frac{1}{M} {\sum }_{i = 1}^{M} {[ f ( {x}_{i} ) - {u}^{reg} ( {x}_{i} ) ]}^{2}$$

Where M is a quantity of regular points, u^{reg}(xᵢ) is a value of a known regular point, and F[dₓƒ(xᵢ), ƒ(xᵢ), xᵢ] in the foregoing formula is defined as follows:

$$F [ {d}_{x} f ( {x}_{i} ) , f ( {x}_{i} ) , {x}_{i} ] = \frac{\partial f ( {x}_{i} )}{\partial x} + f ( {x}_{i} ) \cdot tan {x}_{i} - {x}_{i}^{2} .$$

If a value of a loss function constructed based on the predicted processing result satisfies a preset accuracy condition, the predicted processing result that makes the value of the loss function satisfy the specified accuracy condition is exactly a target processing result of the differential equation; or otherwise, a variational parameter in the differentiable quantum circuits may be updated by using optimization algorithm.

For example, the variational parameter θ is updated by using the following formula according to a conventional optimization method, namely, a gradient descent method, that is, θⁿ⁺¹=θⁿ−α∇_{θ}L, where n is an integer not less than 1, α is a learning rate, ∇_{θ} is a gradient of a loss function with respect to θ, and L is the loss function.

Then, an updated variational parameter is transferred to the differentiable quantum circuit, evolution and measurement in the foregoing steps are continued, and a predicted processing result and a loss function corresponding to the predicted processing result are updated by continuously iterating the variational parameter, until a predicted processing result that makes a value of the loss function satisfy the preset accuracy condition is obtained, and the predicted processing result is used as the target processing result of the differential equation.

For example, still in the foregoing example, after the loss function is constructed, the variational parameters θ₁, θ₂, and θ₃ shown in FIG. 4 need to be updated. A specific updating method is as follows:

$${θ}_{i}^{new} = {θ}_{i}^{current} - α {∇}_{θ} {L}_{θ} [ {d}_{x} f , f , x ]$$

It may be learned from the foregoing formula that, to update the variational parameter θ, a gradient of the loss function with respect to the variational parameter needs to be calculated. A specific mathematical form is as follows:

$$\begin{matrix}{∇}_{{θ}_{i}} {L}_{θ} [ {d}_{x} f , f , x ] = \frac{2}{N} {\sum }_{i = 1}^{N} ( \frac{\partial f ( {x}_{i} )}{\partial x} + f ( {x}_{i} ) \cdot tan {x}_{i} - {x}_{i}^{2} ) ( \frac{\partial f ( {x}_{i} )}{\partial x \partial {θ}_{i}} + \\ \frac{\partial f ( {x}_{i} )}{\partial {θ}_{i}} \cdot tan {x}_{i} ) \\ + 2 ( f ( {x}_{0} ) - {u}_{0} ) \frac{\partial f ( {x}_{0} )}{\partial {θ}_{i}}\end{matrix}$$

Then, the variational parameter θ may be updated according to the gradient calculation method described in the foregoing formula. An updated variational parameter is substituted into the loss function to obtain an updated loss function. The variational parameter may be further updated based on the updated loss function, and the process is repeated until a loss function satisfies a preset accuracy condition. In this case, a predicted processing result obtained when the loss function satisfies the preset accuracy condition may be used as the target processing result of the differential equation.

This implementation is different from a conventional method for solving a differential equation by using a numerical calculation method. Because the method does not need to perform numerical dispersion on a spatial derivative, especially in a case in which a shape of a computational domain is complex, resource consumption caused by grid division may be avoided. In addition, a regular term is added to a loss function, so that existing prior data may be fully utilized to implement solving of a differential equation in another manner.

It may be learned that, in this implementation, data of a data processing task is first acquired, then a differentiable quantum circuit is constructed based on the data of the data processing task, and a target processing result of the data processing task is predicted based on the differentiable quantum circuit. When a value of a loss function constructed based on a predicted processing result obtained through the prediction satisfies a specified accuracy condition, the predicted processing result obtained when the value of the loss function satisfies the specified accuracy condition is used as the target processing result. In this implementation, a loss function can be constructed based on a predicted solution, and a value of the loss function can be updated to implement another processing manner of a task for solving a differential equation, thereby reducing resource consumption caused by grid division.

A differentiable quantum circuit (Differentiable Quantum Circuits, DQC) method has advantages in processing a task to solve a nonlinear differential equation. Therefore, an implementation of this application proposes a method for processing a task to solve a time-dependent partial differential equation by using quantum computation by combining a time discrete technology with the DQC method, which solves a problem that a circuit depth increases due to existence of a time variable, and also reduces difficulty in optimizing a variational parameter.

Referring to FIG. 5, FIG. 5 is a schematic flowchart of the method for processing a task to solve a time-dependent partial differential equation by using a quantum circuit according to an implementation. The following steps may be included.

S201: Acquiring data of a data processing task, where the data processing task is a task to solve a time-dependent partial differential equation; and the data of the data processing task includes the time-dependent partial differential equation.

Partial differential equations are an important branch of modern mathematics. In both theory and practice, partial differential equations are used to describe problems in the fields of mechanics, control process, ecological and economic system, chemical circulation system, epidemic science, and the like. Impact of space and time may be fully taken into account in describing problems by using a partial differential equation. Therefore, a partial differential equation including a time term may be referred to as a time-dependent partial differential equation.

Specifically, the obtained time-dependent partial differential equation is as follows:

$$\frac{\partial u ( x , t )}{\partial t} + {N}^{′} [ u ( x , t ) ] = 0 , x ∈ Ω , t ∈ [ 0 , T ]$$

Where u(x, t) is a solution of the time-dependent partial differential equation, x is a spatial variable, t is a time variable, N′[u(x, t)] is a nonlinear term, Ω is a computational domain, and T is a time. S202: Constructing a differentiable quantum circuit based on the data of the data processing task.

For an implicit difference scheme is the difference scheme, constructing a differentiable quantum circuit may include the following steps.
Step 1: Acquiring a set of qubits and setting an initial state of the qubits to |0 [symbol] .
Step 2: Constructing, by using a first type of quantum logic gates, a first quantum sub-circuit module for generating a function space basis set. A process of constructing the first quantum sub-circuit module is the same as the foregoing process of constructing the first quantum sub-circuit module, and details are not described herein again.
Step 3: Acquiring the initial variational parameter and constructing, by using a second type of quantum logic gates, a second quantum sub-circuit module for combining the function space basis set into a predicted solution of the time-dependent partial differential equation. A process of constructing the second quantum sub-circuit module is the same as the foregoing process of constructing the second quantum sub-circuit module, and details are not described herein again.
Step 4: Constructing a measurement operation module for obtaining the predicted solution of the time-dependent partial differential equation.

Specifically, the measurement operation module acting on a qubit is constructed to measure a final quantum state of the qubit.
Step 5: Sequentially combining the first quantum sub-circuit module, the second quantum sub-circuit module, and the measurement operation module to construct a differentiable quantum circuit.

Specifically, the first quantum sub-circuit module, the second quantum sub-circuit module, and the measurement operation module are sequentially combined to construct a schematic diagram of a differentiable quantum circuit shown in FIG. 3. A black dot and an icon ⊕ in the figure represent a CNOT quantum logic gate, where the black dot is on a control bit of the CNOT quantum logic gate, and the icon ⊕ is on a target bit of the CNOT quantum logic gate.

After a first quantum sub-circuit and a second quantum sub-circuit pass through, information of a quantum circuit needs to be read out, and a final quantum state corresponding to an initial variational parameter needs to be obtained.

S203: Predicting a target processing result of the time-dependent partial differential equation based on an initial variational parameter of the differentiable quantum circuit, and in a case that a value of a loss function at a current time constructed based on the predicted processing result obtained through the prediction satisfies a specified accuracy condition, using a predicted solution, obtained when the value of the loss function satisfies the specified accuracy condition, of the time-dependent partial differential equation as a target solution of the time-dependent partial differential equation.

The predicting a target processing result of the time-dependent partial differential equation based on the initial variational parameter of the differentiable quantum circuit may include the following steps.
Step 1: Determining an initial condition and a boundary condition of the time-dependent partial differential equation.

Specifically, there are generally a plurality of solutions to the time-dependent partial differential equation. However, when a specific physical problem is to be solved, a required solution needs to be selected from the solutions. Therefore, an additional condition, namely, the initial condition and the boundary condition also need to be known.

For example, for the time-dependent partial differential equation to be solved, the initial condition may be preset to u(x, 0)=g(x), x∈Ω, and the boundary condition is preset to u(x, t)=h(x, t), and x∈Γ, where Γ denotes a computational domain boundary.
Step 2: Determining the time-dependent partial differential equation expressed in a semi-discrete format based on a pre-selected difference scheme.

Specifically, the difference scheme is a discretization method for calculating a function derivative by using a numerical method, namely, an algorithm for replacing a derivative or a partial derivative in a partial differential equation by using a difference between two or more adjacent numeric points. Selecting a difference scheme is the first step for discretizing or semi-discretizing the partial differential equation.

For example, in the foregoing example, the time term

$$\frac{\partial u ( x , t )}{\partial t}$$

in the time-dependent partial differential equation is first discretized to obtain

$$\frac{u ( x , t + △ t ) - u ( x , t )}{△ t} .$$

If the pre-selected difference scheme is an implicit difference scheme, the determining the time-dependent partial differential equation expressed in a semi-discrete format based on a pre-selected difference scheme includes:
determining the time-dependent partial differential equation expressed in a semi-discrete format as:

u(x,t+Δt)=u(x,t)+Δt·N′[u(x,t+Δt)]

Where u(x, t+Δt) is a value of a function to be solved at time t+Δt.
Step 3: Predicting a solution of the time-dependent partial differential equation by using the differentiable quantum circuit according to the initial condition and the boundary condition. A prediction process is the same as the foregoing prediction process, and details are not described herein again.

The constructing a loss function at a current time based on a prediction result obtained through the prediction may include the following cases.

If the current time is an initial time, a loss function at the initial time is as follows:

$${L}_{θ} ( 0 ) = \frac{1}{{N}^{′}} {\sum }_{i = 1}^{{N}^{′}} {[ \tilde{u} ( {x}_{i} , 0 ) - g ( {x}_{i} ) ]}^{2} + \frac{1}{M} {\sum }_{{j}^{′} = 1}^{M} {[ \tilde{u} ( {x}_{{j}^{′}} , 0 ) - h ( {x}_{{j}^{′}} , 0 ) ]}^{2}$$

Where N′ is a quantity of discrete points, M is a quantity of boundary points, i is the i^{th} discrete point, j′ is the j′^{th} boundary point, ũ(xᵢ, 0) is a predicted solution at the initial time, g(xᵢ) is an initial condition, and h(xⱼ′,0) is a boundary condition at the initial time.

If the current time is time Δt, a loss function at time Δt is as follows:

$${L}_{θ} ( △ t ) = \frac{1}{{N}^{′}} {\sum }_{i = 1}^{{N}^{′}} {[ \tilde{u} ( {x}_{i} , △ t ) - \tilde{u} ( {x}_{i} , 0 ) - △ t \cdot {N}^{′} [ \tilde{u} ( {x}_{i} , △ t ) ] ]}^{2} + \frac{1}{M} {\sum }_{{j}^{′} = 1}^{M} {[ \tilde{u} ( {x}_{{j}^{′}} , △ t ) - h ( {x}_{{j}^{′}} , △ t ) ]}^{2}$$

Where N′[u(x, t)] is determined based on a differentiable quantum circuit at a previous time.

That the value of the loss function at the current time constructed based on the predicted processing result satisfies the preset accuracy condition is specifically as follows.

A target solution of the time-dependent partial differential equation is further obtained based on the predicted solution of the time-dependent partial differential equation. A predicted solution ƒ_{φ, θ}(x) of the time-dependent partial differential equation at a current time may be obtained when a pre-selected measurement operator Ĥ acts on a final quantum state |ƒ_{φ, θ}(x) [symbol] , and the predicted solution at the current time is substituted into a loss function at a corresponding time to determine whether a value of the loss function satisfies a preset accuracy condition. The preset accuracy condition may be set by a user according to a computing requirement, for example, may be 10⁻⁶ or 0.

If the value of the loss function at the current time constructed based on the predicted solution satisfies the preset accuracy condition, the predicted solution that makes the value of the loss function satisfy the specified accuracy condition is just the target solution of the time-dependent partial differential equation; otherwise, a variational parameter in the differentiable quantum circuits is updated by using optimization algorithm.

For example, the variational parameter θ is updated by using the following formula according to a conventional optimization method, namely, a gradient descent method, that is, θⁿ⁺¹=θₙ−α∇_{θ}L, where n is an integer not less than 1, α is a learning rate, ∇_{θ} is a gradient of a loss function with respect to θ, and L is the loss function.

Then, an updated variational parameter is transferred to the differentiable quantum circuit, evolution and measurement in the foregoing steps are continued, and a predicted solution and a loss function corresponding to the predicted solution are updated by continuously iterating the variational parameter, until a predicted solution that makes a value of the loss function satisfy the preset accuracy condition is obtained, and the predicted solution is used as the target solution of the time-dependent partial differential equation.

For example, the time-dependent partial differential equation is acquired, a differentiable quantum circuit is constructed, and an initial predicted solution of a time-dependent partial differential equation corresponding to an initial variational parameter is acquired, to obtain a loss function at an initial time. A value, obtained through computing, of the loss function at the initial time does not satisfy a preset accuracy 10⁻⁶. A variational parameter in the differentiable quantum circuit is updated by using an optimization algorithm to satisfy an initial condition and a boundary condition that are given in a time-dependent partial differential equation to be solved. The update continues until the initial predicted solution ũ(x, 0) satisfies the initial condition and the boundary condition that are given in the time-dependent partial differential equation, that is, the loss function at the initial time satisfies the preset accuracy condition. Since ũ(x, 0) is an approximate function of u(x, 0), a loss function at time Δt is obtained based on the time-dependent partial differential equation, namely:

$${L}_{θ} ( △ t ) = \frac{1}{{N}^{′}} {\sum }_{i = 1}^{{N}^{′}} {[ \tilde{u} ( {x}_{i} , △ t ) - \tilde{u} ( {x}_{i} , 0 ) - △ t \cdot {N}^{′} [ \tilde{u} ( {x}_{i} , △ t ) ] ]}^{2} + \frac{1}{M} {\sum }_{{j}^{′} = 1}^{M} {[ \tilde{u} ( {x}_{{j}^{′}} , △ t ) - h ( {x}_{{j}^{′}} , △ t ) ]}^{2} ↵$$

An approximate value ũ(xᵢ, Δt) of a predicted solution at the time Δt may be obtained by optimizing the loss function at the time Δt given in the expression, where N′[ũ(xⱼ, Δt)] is determined based on a differentiable quantum circuit at the current time, and then a variational parameter (a parameter in ansatz) is updated. Finally, the foregoing step is repeated until a predicted solution u(x, T) of a time-dependent partial differential equation to be solved at a given time T is obtained.

In this implementation, a time-dependent partial differential equation is semi-discretized and then converted into a time-dependent partial differential equation expressed in a semi-discrete format, and a differentiable quantum circuit is constructed and a predicted solution of a time-dependent partial differential equation corresponding to an initial variational parameter is obtained. A classical data structure is associated with a quantum state in the quantum field, and an evolution operation of encoding a classical data structure into a quantum state is performed, to obtain a quantum state of an evolved quantum circuit. In this case, a quantum superposition characteristic can be used to accelerate a processing speed of a task to solve a time-dependent partial differential equation with relatively high complexity, and expand a simulation application scenario of quantum computation.

The DQC method has advantages in processing tasks to solve an ordinary differential equation and an ordinary differential equation set. However, computation efficiency may be reduced because a differentiable quantum circuit model needs to use a parameter shifting method a plurality of times to compute values of various derivatives in a differential equation.

In a related technology, when a task to solve a differential equation is processed by using a differentiable quantum circuit, a solution of the differential equation in an entire computational domain is directly solved, which has two disadvantages. One disadvantage is that, for a differential equation with a solution that is more complex in property, a method for directly processing a solution task in an entire computational domain may result in less accuracy of a solution in a part of the domain. A reason for this phenomenon is that a capability of expressing a differentiable quantum circuit algorithm, namely, an ability to approximate a solution of the differential equation is limited under a condition of a specific quantity of qubits, a specific quantity of characteristic mapping layers, and a specific quantity of ansatz layers. The other disadvantage is that, even under a condition in which the capability of expressing a differentiable quantum circuit algorithm is sufficient, when the property of the solution is relatively complex in an entire computational domain, directly processing a task to solve the differential equation in the entire computational domain also causes optimization difficulties, which is mainly caused by two reasons. One reason is that complexity of the solution causes difficulties in selecting a set of variational parameters suitable for the entire domain. The other reason is that, in a condition that discrete points have a specific distribution density, a larger domain causes a larger quantity of discrete points, and more constraints are imposed on a predicted solution (a predicted solution on each discrete point needs to satisfy a differential equation and a boundary condition), which results in relatively low optimization efficiency.

Therefore, an implementation of this application proposes a method for processing a task to solve a differential equation by using a quantum computation by combining a domain decomposition technology with a differentiable quantum circuit. A problem of a waste of computing resources caused by performing solving in an entire computational domain by using a differentiable quantum circuit with a relatively large quantity of bits and a relatively deep circuit. In addition, computation efficiency of optimizing a variational parameter is effectively improved.

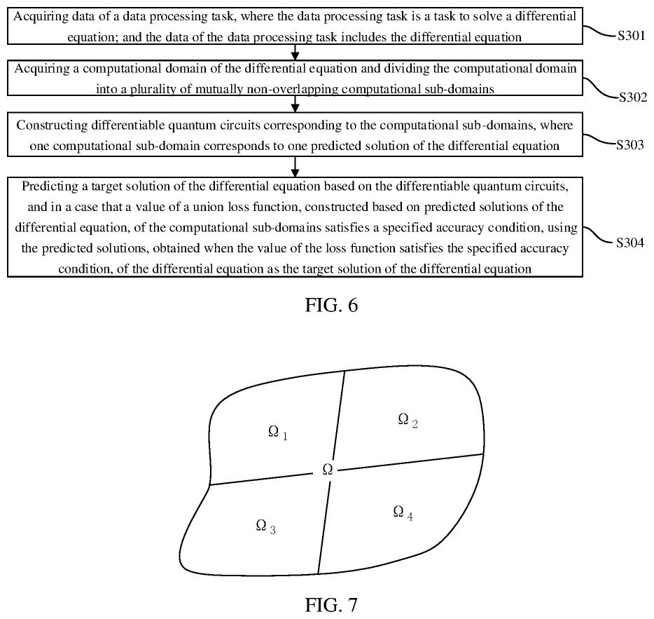

Referring to FIG. 6, FIG. 6 is a schematic flowchart of a method for processing a task to solve a differential equation based on computing domain decomposition according to an implementation. The method may include the following steps.

S301: Acquiring data of a data processing task, where the data processing task is a task to solve a differential equation; and the data of the data processing task includes the differential equation.

Specifically, a differential equation to be solved is as follows:

$$\{ \begin{matrix}F ( {d}_{x} u , u , x ) = 0 \\ u ( {x}_{0} ) = {u}_{0}\end{matrix}$$

Where F is a functional, dₓu is a derivative term, u is a solution of the differential equation to be solved, x is a variable, and u(x₀)=u₀ may be an initial condition or a boundary condition.

S302: Acquiring a computational domain of the differential equation and dividing the computational domain into a plurality of mutually non-overlapping computational sub-domains.

Specifically, a computational domain Ω of the differential equation is decomposed into sub-domains Ω₁, Ω₂, . . . , Ωₙ that do not overlap each other, that is, Ω=Ω₁ ∪Ω₂∪ . . . ∪Ωₙ, where Ωᵢ∈Ω, and i∈1,2, . . . , n.

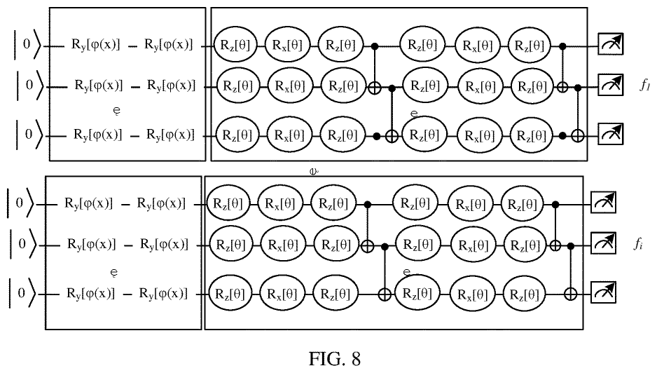

For example, for the following differential equation:

$$\frac{\partial u ( x , t )}{\partial t} + {N}^{′} [ u ( x , t ) ] = 0 , x ∈ Ω , t ∈ [ 0 , T ]$$

Where u(x, t) is a solution of the differential equation, x is a spatial variable, t is a time variable, N′[u(x, t)] is a nonlinear term, Ω is a computational domain, and T is a time. The computational domain Ω is divided into four computational sub-domains that do not overlap each other as shown in FIG. 7. It should be noted that, there are generally a plurality of solutions to the differential equation. However, when a specific physical problem is to be solved, a required solution needs to be selected from the solutions. Therefore, an additional condition, namely, the boundary condition also needs to be known.

S303: Constructing differentiable quantum circuits corresponding to the computational sub-domains, where one computational sub-domain corresponds to one predicted solution of the differential equation. Specifically, a process of constructing a differentiable quantum circuit corresponding to one sub-domain is the same as the process of constructing a differentiable quantum circuit in the foregoing two implementations, and details are not described herein again.

S304: Predicting a target solution of the differential equation based on the differentiable quantum circuits, and in a case that a value of a union loss function, constructed based on predicted solutions of the differential equation, of the computational sub-domains satisfies a specified accuracy condition, using the predicted solutions, obtained when the value of the loss function satisfies the specified accuracy condition, of the differential equation as the target solution of the differential equation. A prediction process is substantially the same as the prediction process in the foregoing implementation, and details are not described herein again.

It should be noted that, one differentiable quantum circuit corresponding to one sub-domain is constructed according to the foregoing method, one predicted solution of the differential equation is acquired, and a quantity of computational sub-domains that are not overlapped divided from a computational domain of the differential equation is determined, and a schematic diagram of a corresponding quantity of differentiable quantum circuits shown in FIG. 8 is constructed, where ƒᵢ denotes a predicted solution of a computational sub-domain Ωᵢ, and predicted solutions ƒᵢ of respective computational sub-domains are mutually independent. For a domain in which flow is more complex or a property of a solution of the differential equation is more complex, a differentiable quantum circuit with a large quantity of qubits and a deep circuit may be used.

The constructing a union loss function based on the predicted solutions of the differential equation may include:

$${L}_{θ} ( 0 ) = {\sum }_{i = 1}^{n} {L}_{i}^{( diff )} [ {d}_{x} {f}_{i} , {f}_{i} , x ] + {\sum }_{i = 1}^{n} {L}_{i}^{( boundary )} [ {f}_{i} , x ] + {\sum }_{i = 1}^{{n}_{b}} {L}_{i}^{( interface )} [ f , x ]$$

Where n is a quantity of sub-domains, n_{b} is a quantity of interfaces, Lᵢ^{(diff)}[dₓƒᵢ, ƒᵢ, x] is an error caused when a predicted solution corresponding to the i^{th} sub-domain does not satisfy the differential equation, Lᵢ^{(boundary)}[ƒᵢ,x] is an error caused when the predicted solution corresponding to the i^{th} sub-domain does not satisfy the boundary condition, Lᵢ^{(interface)} [ƒ, x] is an error caused when predicted solutions corresponding to adjacent computational sub-domains on two sides of the i^{th} interface do not satisfy an interface continuity condition and

$${L}_{i}^{( interface )} [ f , x ] = \frac{1}{{n}_{i}} {\sum }_{j = 1}^{{n}_{i}} {( {f}^{+} ( {x}_{j} ) - {f}^{-} ( {x}_{j} ) )}^{2} ,$$

nᵢ is a quantity of discrete points on the i^{th} interface, and ƒ⁺(xⱼ) and ƒ⁻(xⱼ) are predicted solutions corresponding to sub-domains on two sides of the interface.

Whether a value of a union loss function constructed based on the predicted solutions of the differential equation satisfies accuracy condition is specifically as follows.

A target solution of the differential equation is further obtained based on the predicted solutions ƒᵢ of the differential equation in respective computational sub-domains. The respective predicted solutions ƒᵢ(x) of the differential equation is obtained when a pre-selected measurement operator Hi acts on respective final quantum states |ƒᵢ (x) [symbol] , and the predicted solutions are substituted into a union loss function to determine whether a value of the union loss function satisfies a preset accuracy condition. The preset accuracy condition may be set by a user according to a computing requirement, for example, may be 10⁻⁶ or 0.

If a value of the union loss function constructed based on the predicted solutions satisfies the preset accuracy condition, the predicted solutions that make the value of the loss function satisfy the specified accuracy condition are just the target solution of the differential equation; otherwise, a variational parameter in the differentiable quantum circuits is updated by using optimization algorithm. An optimization process of the variational parameter is substantially the same as an optimization process of the variational parameter in the foregoing implementations, and details are not described herein again.

In this implementation, differentiable quantum circuits are constructed and solutions of the differential equation are predicted based on the differentiable quantum circuits. A classical data structure is associated with a quantum state in the quantum field, and an evolution operation of encoding a classical data structure into a quantum state is performed, to obtain quantum states of evolved quantum circuits. In this case, a quantum superposition characteristic can be used to accelerate a processing speed of a task to solve a differential equation with relatively high complexity, and expand a simulation application scenario of quantum computation.

A numerical method is used to compute a derivative when a parameter shift method of a DQC cannot be used; however, in this case, a numerical error may be caused.

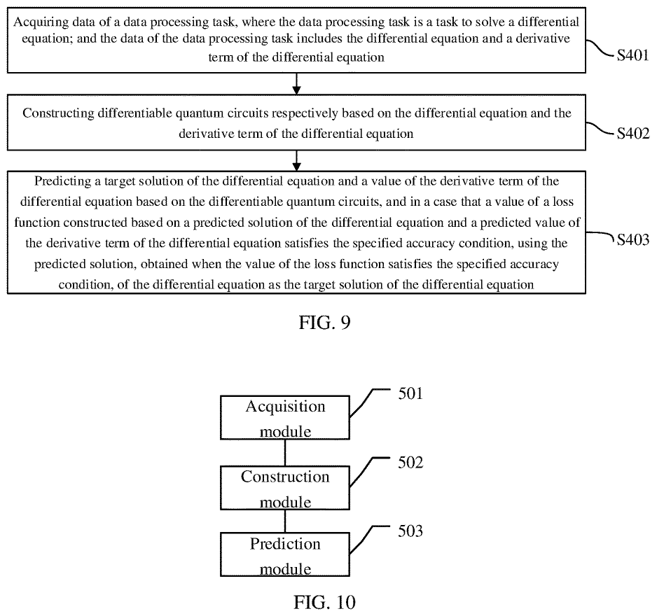

Referring to FIG. 9, FIG. 9 is a schematic flowchart of a method for processing a solving task of a differential equation by using a quantum circuit according to an implementation in this application. The method may include the following steps.

S401: Acquiring data of a data processing task, where the data processing task is a task to solve a differential equation; and the data of the data processing task includes the differential equation and a derivative term of the differential equation.

It should be noted that, in this implementation, the following uses a differentiable quantum circuit to process solving predicted values of the derivative terms of the differential equation in a task to solve the differential equation, where the derivative terms of the differential equation may be classified into different categories. For example, derivative terms

$$\frac{\partial u}{\partial x} and {( \frac{\partial u}{\partial x} )}^{2}$$

may be classified into one category, derivative terms

$$\frac{{\partial }^{2} u}{\partial {x}^{2}} and {( \frac{{\partial }^{2} u}{\partial {x}^{2}} )}^{2}$$

may be classified into one category, and the like. A key to classification lies in whether a same segment of differentiable quantum circuit can be used to solve the predicted values of the derivative terms.

Specifically, the determining a differential equation to be solved is as follows:

$$\{ \begin{matrix}F ( {d}_{x} u , u , x ) = 0 \\ u ( {x}_{0} ) = {u}_{0}\end{matrix}$$

Wherein F is a functional, dₓu is a derivative term, u is a predicted solution of the differential equation to be solved, x is a variable, and u(x₀)=u₀ may be an initial condition or a boundary condition.

For example, for a specific differential equation to be solved,

$$\frac{\partial u}{\partial x} + u tan x = 0$$

Where

$$\frac{\partial u}{\partial x}$$

is a derivative term, u is a solution of the differential equation to be solved, and x is a variable.

S402: Constructing differentiable quantum circuits respectively based on the differential equation and the derivative term of the differential equation.

Specifically, the constructing differentiable quantum circuits respectively based on the differential equation and the derivative term of the differential equation may include:

A first differentiable quantum circuit is constructed based on the differential equation, a second differentiable quantum circuit is constructed based on the derivative term of the differential equation, and a predicted solution of a differential equation corresponding to a current variational parameter in the first differentiable quantum circuit and a predicted value of a derivative term of a differential equation corresponding to a current variational parameter in the second differentiable quantum circuit are separately determined. A process of separately constructing the first differentiable quantum circuit and the second differentiable quantum circuit respectively based on the differential equation and the derivative term of the differential equation is substantially the same as that of the foregoing implementation, and details are not described herein again.

S403: Predicting a target solution of the differential equation and a value of the derivative term of the differential equation based on the differentiable quantum circuits, and in a case that a value of a loss function constructed based on a predicted solution of the differential equation and a predicted value of the derivative term of the differential equation satisfies the specified accuracy condition, using the predicted solution, obtained when the value of the loss function satisfies the specified accuracy condition, of the differential equation as the target solution of the differential equation. A prediction process is substantially the same as the prediction process in the foregoing implementations, and details are not described herein again.

It should be noted that, one differentiable quantum circuit corresponding to each category of derivative terms is constructed and predicted values of derivative terms are acquired according to the foregoing method, where predicted values of each category of derivative terms are separately represented, and prediction values of the respective derivative terms are mutually independent.

The loss function constructed based on the predicted solution of the differential equation and the predicted value of the derivative term of the differential equation that are obtained based on the differentiable quantum circuits is as follows:

L[ƒⁱ,ƒ,x]=L^{(diff)}[ƒⁱ,ƒ,x]+L^{(boundary)}[ƒ,x]

Where ƒⁱ denotes the i^{th} order derivative term in the differential equation, L^{(diff)} denotes an error generated when the predicted solution does not satisfy the differential equation, ƒ denotes the differential equation, x denotes a variable, and L^{(boundary)} denotes an error generated when the predicted solution does not satisfy a boundary condition and an initial condition.

Whether a value of the loss function constructed based on the predicted solution of the differential equation and the predicted value of the derivative term of the differential equation satisfies a preset accuracy condition is as follows.

A target solution of the differential equation is further obtained based on the predicted solutions of the differential equation and the predicted values of the derivative terms of the differential equation that are obtained in respective differentiable quantum circuits. The respective predicted solutions ƒᵢ(x) of the differential equation and the respective predicted values ƒᵢ′(x) of the derivative terms are obtained when a pre-selected measurement operator Ĥ acts on respective final quantum states, and the predicted solutions and the predicted values are substituted into the loss function to determine whether a value of the loss function satisfies a preset accuracy condition. The preset accuracy condition may be set by a user according to a computing requirement, for example, may be 10⁻⁶ or 0.

If a value of the loss function constructed based on the predicted solutions and the predicted values satisfies the preset accuracy condition, the predicted solution that makes the value of the loss function satisfy the specified accuracy condition is just the target solution of the differential equation; otherwise, variational parameters in respective differentiable quantum circuits are simultaneously updated by using optimization algorithm. An optimization process of the variational parameters is substantially the same as an optimization process of the variational parameter in the foregoing implementations, and details are not described herein again.

In this implementation, differentiable quantum circuits are constructed, and solutions of the differential equation and values of derivative terms of the differential equation are predicted based on the differentiable quantum circuits. A classical data structure is associated with a quantum state in the quantum field, and an evolution operation of encoding a classical data structure into a quantum state is performed, to obtain quantum states of evolved quantum circuits. In this case, a quantum superposition characteristic can be used to accelerate a processing speed of a task to solve a differential equation with relatively high complexity, and expand a simulation application scenario of quantum computation.

Referring to FIG. 10, FIG. 10 is a schematic structural diagram of an apparatus for processing a data processing task according to an implementation of this application. Corresponding to the process shown in FIG. 2, the apparatus may include the following:
an acquisition module 501, configured to acquire data of a data processing task, where the data processing task is a task to solve a differential equation; and the data of the data processing task includes the differential equation;
a construction module 502, configured to construct a differentiable quantum circuit based on the data of the data processing task; and
a prediction module 503, configured to: predict a target processing result of the data processing task based on the differentiable quantum circuit; and in a case that a value of a loss function constructed based on a predicted processing result obtained through the prediction satisfies a specified accuracy condition, use the predicted processing result obtained when the value of the loss function satisfies the specified accuracy condition as the target processing result.

Specifically, the obtaining module 501 includes the following:
an acquisition unit, configured to acquire information of the differential equation as well as an initial condition and a boundary condition that are satisfied by a solution of the differential equation.

The construction module 502 includes the following:
a construction unit, configured to: construct a differentiable quantum circuit and determine a variational parameter in the differentiable quantum circuit.

Specifically, the construction unit includes the following:
a first acquisition subunit, configured to acquire a set of qubits and set an initial state of the qubits to |0 [symbol] ;
a first construction subunit, configured to construct, by using a first type of quantum logic gates, a first quantum sub-circuit module for generating a function space basis set;
a second construction subunit, configured to construct, by using a second type of quantum logic gates, a second quantum sub-circuit module for combining the function space basis set into a predicted solution of the differential equation;
a third construction subunit, configured to construct a measurement operation module for obtaining the predicted solution of the differential equation; and
a combination subunit, configured to sequentially combine the first quantum sub-circuit module, the second quantum sub-circuit module, and the measurement operation module to obtain the differentiable quantum circuit.

The prediction module 503 includes the following:
a prediction unit, configured to obtain the predicted solution of the differential equation by using the differentiable quantum circuit according to the initial condition and the boundary condition;
a determining unit, configured to determine whether a loss function constructed based on the predicted solution of the differential equation satisfies a preset accuracy condition; and
an updating unit, configured to update, by using an optimization algorithm, a variational parameter for a predicted solution of the differential equation in which a loss function fails to satisfy the preset accuracy condition, to obtain a predicted solution, corresponding to an updated variational parameter, of the differential equation.

Specifically, the updating unit includes the following:
an updating subunit, configured to update a variational parameter θ by using the following formula: θⁿ⁺¹=θⁿ−α∇_{θ}L.

Where n is an integer not less than 1, α is a learning rate, ∇_{θ} is a gradient of a loss function with respect to θ, and L is the loss function.

An implementation of this application further provides a storage medium, where the storage medium stores a computer program. When the computer program is run, the steps in any one of the foregoing implementations are performed.

Specifically, in this implementation, the storage medium may include but is not limited to any medium that may store a computer program, for example, a USB flash drive, a read-only memory (Read-Only Memory, ROM), a random access memory (Random Access memory, RAM), a removable hard disk, a magnetic disk, or an optical disc.

An implementation of this application further provides an electronic apparatus, including a memory and a processor. The memory stores a computer program. The processor is configured to run the computer program, so that the steps in any one of the foregoing method embodiments are performed.

Specifically, the electronic apparatus may further include a transmit device and an input/output device. The transmit device is connected to the processor. The input/output device is connected to the processor.

The constructions, features, functions, and effect of the present application are described in detail in the embodiments with reference to the accompanying drawings. The foregoing is merely preferred embodiments of the present application, and the present application is not limited by the accompanying drawings. All equivalent embodiments that are modified or changed according to the concept of the present application and do not depart from the spirit of the specification and the drawings should fall within the protection scope of the present application.

What is claimed is:

1. A method for processing a data processing task, comprising:
acquiring data of a data processing task, wherein the data processing task is a task to solve a differential equation; and the data of the data processing task comprises the differential equation;
constructing a differentiable quantum circuit based on the data of the data processing task; and
predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result.

2. The method according to claim 1, wherein the predicting a target processing result of the data processing task based on the differentiable quantum circuit comprises:
predicting a target solution of the differential equation based on a variational parameter in the differentiable quantum circuit.

3. The method according to claim 1, wherein the data of the data processing task further comprises an initial condition and a boundary condition satisfied by a solution of the differential equation; and the constructing a differentiable quantum circuit based on the data of the data processing task comprises:
constructing the differentiable quantum circuit based on the differential equation as well as the initial condition and boundary condition that are satisfied by the solution of the differential equation, and determining a variational parameter in the differentiable quantum circuit.

4. The method according to claim 3, wherein constructing the differentiable quantum circuit based on the differential equation and the initial condition and boundary condition satisfied by the solution of the differential equation comprises:
acquiring a set of qubits and setting an initial state of the qubits to |0 [symbol] ;
constructing, by using a first type of quantum logic gates, a first quantum sub-circuit module for generating a function space basis set;
constructing, by using a second type of quantum logic gates, a second quantum sub-circuit module for combining the function space basis set into a predicted solution of the differential equation;
constructing a measurement operation module for obtaining the predicted solution of the differential equation; and
sequentially combining the first quantum sub-circuit module, the second quantum sub-circuit module, and the measurement operation module to obtain the differentiable quantum circuit.

5. The method according to claim 2, wherein the predicting a target solution of the differential equation based on a variational parameter in the differentiable quantum circuit comprises:
updating the variational parameter by using an optimization algorithm, and predicting the target solution of the differential equation based on the updated variational parameter;
the updating the variational parameter by using an optimization algorithm comprises:
updating the variational parameter θ by using the following equation:
θⁿ⁺¹=θⁿ−α∇_{θ}L
wherein n is an integer not less than 1, α is a learning rate, L is a loss function, and ∇θ is a gradient of the loss function with respect to θ.

6. The method according to claim 5, wherein the loss function is as follows:
$${L}_{θ} ( {d}_{x} f , f , x ) = {L}_{θ}^{( diff )} [ {d}_{x} f , f , x ] + {L}_{θ}^{( boundary )} [ f , x ] + {L}_{θ}^{reg} [ f , x ]$$
wherein L_{θ}^{(diff)} denotes an error generated when the predicted solution of the differential equation does not satisfy the differential equation, dₓƒ denotes a derivative term in the differential equation, f denotes a function corresponding to the differential equation, x denotes a variable, L_{θ}^{(boundary)} denotes an error generated when the predicted solution of the differential equation does not satisfy the boundary condition and the initial condition, and
$${L}_{θ}^{reg} [ f , x ]$$
denotes an error of a regular term.

7. The method according to claim 1, wherein the differential equation is a time-dependent partial differential equation, and the predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result comprise:
predicting a target solution of the time-dependent partial differential equation based on an initial variational parameter of the differentiable quantum circuit, and in a case that a value of a loss function at a current time constructed based on the predicted processing result obtained through the prediction satisfies the specified accuracy condition, using a predicted solution, obtained when the value of the loss function satisfies the specified accuracy condition, of the time-dependent partial differential equation as the target solution of the time-dependent partial differential equation;
the time-dependent partial differential equation comprises:
$$\frac{\partial u ( x , t )}{\partial t} + {N}^{′} [ u ( x , t ) ] = 0 , x ∈ Ω , t ∈ [ 0 , T ]$$
wherein u(x,t) is a solution of the time-dependent partial differential equation, x is a spatial variable, t is a time variable, N′[u(x, t)] is a nonlinear term, Ω is a computational domain, and T is a time.

8. The method according to claim 7, wherein the data of the data processing task further comprises an initial condition and a boundary condition of the time-dependent partial differential equation; and
after the acquiring data of a data processing task, the method further comprises:
determining the time-dependent partial differential equation expressed in a semi-discrete format based on a pre-selected difference scheme;
the pre-selected difference scheme is an implicit difference scheme; and the determining the time-dependent partial differential equation expressed in a semi-discrete format based on a pre-selected difference scheme comprises:
determining the time-dependent partial differential equation expressed in a semi-discrete format as:
u(x,t+Δt)=u(x,t)+Δt·N′[u(x,t+Δt)]
wherein u(x, t+Δt) is a solution of the time-dependent partial differential equation at time t+Δt.

9. The method according to claim 8, wherein the predicting a target solution of the time-dependent partial differential equation based on an initial variational parameter of the differentiable quantum circuit comprises:
acquiring a set of qubits and setting an initial state of the qubits to |0 [symbol] ;
constructing, by using a first type of quantum logic gates, a first quantum sub-circuit module for generating a function space basis set;
acquiring the initial variational parameter and constructing, by using a second type of quantum logic gates, a second quantum sub-circuit module for combining the function space basis set into a predicted solution of the time-dependent partial differential equation;
constructing a measurement operation module for obtaining the predicted solution of the time-dependent partial differential equation; and
sequentially combining the first quantum sub-circuit module, the second quantum sub-circuit module, and the measurement operation module to construct the differentiable quantum circuit, and determining the predicted solution of the time-dependent partial differential equation based on a final quantum state corresponding to the initial variational parameter.

10. The method according to claim 9, wherein the determining the predicted solution of the time-dependent partial differential equation comprises:
acquiring a pre-selected measurement operator;
determining an expected value corresponding to the measurement operator based on the final quantum state; and
determining the predicted solution of the time-dependent partial differential equation based on the expected value.

11. The method according to claim 9, wherein the first type of quantum logic gates comprises an Rx quantum logic gate, an Ry quantum logic gate, and an Rz quantum logic gate; and
the second type of quantum logic gates comprises an Rx quantum logic gate, an Ry quantum logic gate, an Rz quantum logic gate, and a CNOT quantum logic gate.

12. The method according to claim 7, wherein the loss function at the current time constructed based on the predicted processing result obtained through the prediction comprises:
when the current time is an initial time, a loss function at the initial time is as follows:
$${L}_{θ} ( 0 ) = \frac{1}{{N}^{′}} {\sum }_{i = 1}^{{N}^{′}} {[ \tilde{u} ( {x}_{i} , 0 ) - g ( {x}_{i} ) ]}^{2} + \frac{1}{M} {\sum }_{{j}^{′} = 1}^{M} {[ \tilde{u} ( {x}_{{j}^{′}} , 0 ) - h ( {x}_{{j}^{′}} , 0 ) ]}^{2}$$
wherein N′ is a quantity of discrete points, M is a quantity of boundary points, i is the i^{th} discrete point, j′ is the j′^{th} boundary point, ũ(xᵢ, 0) is a predicted processing result at the initial time, g(xi) is an initial condition, and h(xj′, 0) is a boundary condition at the initial time;
when the current time is time Δt, a loss function at time Δt is as follows:
$${L}_{θ} ( Δ t ) = \frac{1}{{N}^{′}} {\sum }_{i = 1}^{{N}^{′}} {[ \tilde{u} ( {x}_{i} , Δ t ) - \tilde{u} ( {x}_{i} , 0 ) - Δ t \cdot {N}^{′} [ \tilde{u} ( {x}_{i} , Δ t ) ] ]}^{2} + \frac{1}{M} {\sum }_{{j}^{′} = 1}^{M} {[ \tilde{u} ( {x}_{{j}^{′}} , Δ t ) - h ( {x}_{{j}^{′}} , Δ t ) ]}^{2}$$
wherein N′[u(x, t)] is determined based on a differentiable quantum circuit at a previous time.

13. The method according to claim 1, wherein after the acquiring data of a data processing task, the method further comprises:
acquiring a computational domain of the differential equation and dividing the computational domain into a plurality of mutually non-overlapping computational sub-domains;
the constructing a differentiable quantum circuit based on the data of the data processing task comprises:
constructing differentiable quantum circuits corresponding to the computational sub-domains, wherein one computational sub-domain corresponds to one predicted solution of the differential equation; and
the predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result comprise:
predicting a target solution of the differential equation based on the differentiable quantum circuits, and in a case that a value of a union loss function, constructed based on predicted solutions of the differential equation, of the computational sub-domains satisfies the specified accuracy condition, using the predicted solutions, obtained when the value of the loss function satisfies the specified accuracy condition, of the differential equation as the target solution of the differential equation.

14. The method according to claim 13, wherein the differential equation is as follows:
$$\{ \begin{matrix}F ( {d}_{x} u , u , x ) = 0 \\ u ( {x}_{0} ) = {u}_{0}\end{matrix}$$
wherein F is a functional, dₓu is a derivative term, u is a solution of the differential equation, and x is a variable.

15. The method according to claim 13, wherein the union loss function is as follows:
$${L}_{θ} ( 0 ) = {\sum }_{i = 1}^{n} {L}_{i}^{( diff )} [ {d}_{x} {f}_{i} , {f}_{i} , x ] + {\sum }_{i = 1}^{n} {L}_{i}^{( boundary )} [ {f}_{i} , x ] + {\sum }_{i = 1}^{{n}_{b}} {L}_{i}^{( interface )} [ f , x ]$$
wherein n is a quantity of computational sub-domains, n_{b} is a quantity of interfaces, Lᵢ^{(diff)}[dₓƒᵢ, ƒᵢ,x] is an error caused when a predicted solution of the differential equation corresponding to the i^{th} computational sub-domain does not satisfy the differential equation, Lᵢ^{(boundary)}[ƒᵢ x] is an error caused when a predicted solution of the differential equation corresponding to the i^{th} computational sub-domain does not satisfy a boundary condition satisfied by a solution of the differential equation, Lᵢ^{(interface)}[ƒ, x] is an error caused when predicted solutions of the differential equation corresponding to adjacent computational sub-domains on two sides of the i^{th} interface do not satisfy an interface continuity condition and
$${L}_{i}^{( interface )} [ f , x ] = \frac{1}{{n}_{i}} {\sum }_{j = 1}^{{n}_{i}} {( {f}^{+} ( {x}_{j} ) - {f}^{-} ( {x}_{j} ) )}^{2} ,$$
nᵢ is a quantity of discrete points on the i^{th} interface, and ƒ⁺(xⱼ) and ƒ⁻(xⱼ) are the predicted solutions of the differential equation corresponding to computational sub-domains on two sides of the interface.

16. The method according to claim 1, wherein the data of the data processing task further comprises a derivative term of the differential equation;
the constructing a differentiable quantum circuit based on the data of the data processing task comprises:
constructing differentiable quantum circuits respectively based on the differential equation and the derivative term of the differential equation; and
the predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result comprise:
predicting a target solution of the differential equation and a value of the derivative term of the differential equation based on the differentiable quantum circuits, and in a case that a value of a loss function constructed based on a predicted solution of the differential equation and a predicted value of the derivative term of the differential equation satisfies the specified accuracy condition, using the predicted solution, obtained when the value of the loss function satisfies the specified accuracy condition, of the differential equation as the target solution of the differential equation.

17. The method according to claim 16, wherein the constructing differentiable quantum circuits respectively based on the differential equation and the derivative term of the differential equation comprises:
respectively constructing differentiable quantum circuits for solving the predicted solution of the differential equation and for solving the predicted value of the derivative term of the differential equation, and determining the predicted solution of the differential equation and the predicted value of the derivative term of the differential equation that are corresponding to variational parameters in the differentiable quantum circuits respectively;
the respectively constructing differentiable quantum circuits for solving the predicted solution of the differential equation and for solving the predicted value of the derivative term comprises:
separately acquiring a set of qubits and setting an initial state of the qubits to |0 [symbol] ;
separately constructing, by using a first type of quantum logic gates, a first quantum sub-circuit module for generating a function space basis set;
constructing, by using a second type of quantum logic gates, second quantum sub-circuit modules for combining function space basis sets into the predicted solution of the differential equation and the predicted value of the derivative term of the differential equation respectively;
respectively constructing measurement operation modules for obtaining the predicted solution of the differential equation and the predicted value of the derivative term of the differential equation, and
separately combining the first quantum sub-circuit module, the second quantum sub-circuit module, and the measurement operation module to construct the differentiable quantum circuit.

18. The method according to claim 16, wherein the loss function is as follows:
L[ƒⁱ,ƒ,x]=L^{(diff)}[ƒⁱ,ƒ,x]+L^{(boundary)}[ƒ,x]
wherein ƒⁱ denotes the i^{th} order derivative term in the differential equation, L^{(diff)} denotes an error generated when the predicted solution of the differential equation does not satisfy the differential equation, ƒ denotes the differential equation, x denotes a variable, and L^{(boundary)} denotes an error generated when the predicted solution of the differential equation does not satisfy a boundary condition and an initial condition of the solution of the differential equation.

19. A non-transitory computer-readable storage medium, wherein the non-transitory computer-readable storage medium stores a computer program, and when the computer program is run, the following method is performed:
acquiring data of a data processing task, wherein the data processing task is a task to solve a differential equation; and the data of the data processing task comprises the differential equation;
constructing a differentiable quantum circuit based on the data of the data processing task; and
predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result.

20. An electronic device, comprising a memory and a processor, wherein the memory stores a computer program, and the processor is configured to run the computer program, so that the following method is performed:
acquiring data of a data processing task, wherein the data processing task is a task to solve a differential equation; and the data of the data processing task comprises the differential equation;
constructing a differentiable quantum circuit based on the data of the data processing task; and
predicting a target processing result of the data processing task based on the differentiable quantum circuit; and in a case that a value of a loss function constructed based on a predicted processing result obtained through the prediction satisfies a specified accuracy condition, using the predicted processing result obtained when the value of the loss function satisfies the specified accuracy condition as the target processing result.
